(19) United States
(12) Patent Application Publication
(10) Pub. No.: US 2010/0313110 A1
(43) Pub. Date: Dec. 9, 2010

(54) METHOD AND APPARATUS FOR THE DISPLAY AND/OR PROCESSING OF INFORMATION, SUCH AS DATA

(75) Inventors: Dennis Gladstone Claridge, Sandringham (AU); Mark Anthony Stammers, Northcote (AU)

Correspondence Address: SUGHRUE MION, PLLC, 2100 PENNSYLVANIA AVENUE, N.W., SUITE 800, WASHINGTON, DC, 20037, US

(73) Assignee: DOUBLEIQ PTY LTD, Melbourne, Victoria (AU)

(21) Appl. No.: 12/747,999

(22) PCT Filed: Dec. 11, 2008
(86) PCT No.: PCT/AU08/01819

§ 371 Date: Aug. 25, 2010

(30) Foreign Application Priority Data
Dec. 14, 2007 (AU) 2007906758

(51) Int. Cl. G06F 17/24; G06F 3/048

(52) U.S. Cl. 715/212; 715/801

(57) ABSTRACT

The present invention relates to the field of information display as well as information processing. An example of the information may be data. A number of inventive aspects are disclosed in this specification. In a first aspect of invention, the invention relates to the manner in which windows are displayed and tiled, for example on a computer. In one embodiment, the invention relates to the resizing of display windows. In a second aspect of invention, the invention relates to the processing of information. In one embodiment, the invention relates to any spreadsheet, matrix, redefinition hierarchy, the building of mathematical models and/or circular reference.

### FIELD OF INVENTION

The present invention relates to the field of information display as well as information processing. An example of the information may be data. A number of inventive aspects are disclosed in this specification.

In a first aspect of invention, the invention relates to the manner in which windows are displayed, for example on a computer. In one embodiment, the invention relates to the resizing of display windows.

In a second aspect of invention, the invention relates to the processing of information. In one embodiment, the invention relates to any spreadsheet, matrix, redefinition hierarchy, the building of mathematical models and/or circular reference.

It will be convenient to hereinafter describe the invention in relation to the aspects above, however it should be appreciated that the present invention is not limited to that use only.

### BACKGROUND ART

Throughout this specification the use of the word “inventor” in singular form may be taken as reference to one (singular) inventor or more than one (plural) inventor of the present invention. The dismission throughout this specification comes about due to the realisation of the inventor(s) and/or the identification of certain prior art problems by the inventors.

With regard to the first aspect, when there is a need to display multiple windows on a computer screen. Current windows based interfaces provide a tiling process where all current open windows are arranged in a rectangle framework such that the majority of windows all have a similar area of screen space and are adjacent (tiled) to each other.

Under current windows systems, once the tiling is executed, the window boundaries still remain independent from one another i.e. they can be resized independently. If one window is enlarged then this will begin to cover one or more of the other windows.

This is a problem if you want to both enlarge a window but also maintain a non obscured view or the other windows. A non obscured view in this context is one where you can see all of the boundaries of all open windows.

This independent resizing has been found to make it difficult to reconfigure the tiling in such a way that the windows differ in the amount of screen space area they occupy and yet remain adjacent.

To remain unobscured and adjacent, all windows that are not being directly resized need to change their size based on changes to the size of the window being directly controlled.

Such a capability would allow a user to switch focus to a different window, enlarge the window with the focus but still want to have an unobscured view of the other windows.

The ‘Slider’ window control item that is common in modern graphical interface designs achieves this objective but only in the restrictive case where all the dependant windows are either exclusively vertically or exclusively horizontally aligned.

With regard to the second aspect, spreadsheets, such as EXCEL™ by Microsoft Corp, are used to process and/or display information. Each ‘cell’ of the spreadsheet can be only an input or a formula.

U.S. Pat. No. 6,199,078 (Brittan et al) relates to resolving circular references in data networks. It does this by first identifying that a circular reference exists and then providing an algorithm to resolve the conflict via choosing an appropriate path thru the network based on certain rules. Note that the disclosure does not alter formulas used in cells.

The inventors have realised, however, that there is a need for greater processing power in a spreadsheet format. Many organizational processes can be modelled as a Redefinition Hierarchy i.e. a hierarchy that redefines itself as it moves down the hierarchy and where each new, lower level node has more detail than it's parent node and in turn the higher levels become summaries of those below. A Chart of Accounts is an example of a Redefinition Hierarchy.

Generally, for such a hierarchy to be useful then all the nodes in the hierarchy must share at least one attribute that is ‘Additive’ i.e. an Attribute that each node on the Chart may also have other additive attributes e.g. ‘Number of Sales’. Usually software systems will only allow the user to update a Redefinition Hierarchy from the bottom up i.e. from the leaf nodes and any update of one additive attribute will not change the value of another.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

An object of the present invention, in accordance with the first aspect, is to provide for the resizing of a window in a diagonal direction with one gesture whilst also maintaining a non obscured view of other windows.

An object of the present invention, in accordance with the second aspect, is to provide a more flexible manner of processing information, such as data.

A further object of the present invention is to alleviate at least one disadvantage associated with the prior art.

It is an object of the embodiments described herein to overcome or alleviate at least one of the above noted drawbacks of related art systems or to at least provide a useful alternative to related art systems.

In a first aspect of embodiments described herein there is provided a method of, application and/or device for resizing a plurality of windows adapted to be displayed in a tiled format on a screen, the method comprising the steps of providing a first slider in a first axis to delineate the boundary of at least two windows along the first axis, providing a second slider in a second axis to delineate the boundary of at least two windows along the second axis, and providing at the intersect of the first and second sliders, an intersect button adapted to enable resizing of the windows.

In another aspect of embodiments described herein there is provided an application, method and/or device adapted to resize a plurality of windows displayed in a tiled format on a screen, comprising a first slider means in a first axis to delineate the boundary of at least two windows along the first axis, a windows along the second axis, and at the intersect of the first and second sliders, an intersect button adapted to enable resizing of the windows.

In a further aspect of embodiments described herein there is provided a method of, application and/or device for coordinating relationships between a number of cells in a matrix, the method comprising the steps of providing cells with an additive hierarchy relationship, and providing cells with an objectives relationship.

In a still further aspect of embodiments described herein there is provided a matrix, such as an electronic document, spreadsheet or the like, comprising a plurality of first and second cells, the first cells having an additive relationship, the second cells having an objectives relationship.

In yet a further aspect of embodiments described herein there is provided a method of, application and/or device for enabling edit space associated with a matrix as herein disclosed.

Other aspects and preferred aspects are disclosed in the specification and/or defined in the appended claims, forming a part of the description of the invention.

In essence, embodiments of the present invention stem from the realization that, for the first aspect, all the window boundaries on the same vertical and/or horizontal axis move in the same direction for the same absolute amount. The resizing dependencies are based on the valid movements for three user interface components (control items), the Intersect Button, the horizontal slider and the vertical slider.

Horizontal sliders separate rows of windows, whilst vertical sliders separate columns of windows.

For the second aspect, in essence, embodiments of the present invention stem from the realization that, as one embodiment, a method to update a Hierarchy from any node in the hierarchy and from any additive attribute on a node i.e. it describes how to build a Smart Hierarchy. Another way of looking at it is that, this aspect relates to how the hierarchy of nodes and their attributes form a matrix of cells linked by multidirectional formulas where each cell can act in both input and output modes i.e. a specific cell can be used in either input and output cells. In a further embodiment, this aspect of invention also relates to how this ‘Smart Hierarchy’ operates in a shared, multi user (session) environment where different parts of the hierarchy can be simultaneously viewed and updated by different users and yet still remain consistent with the specified formulas. The approach of this aspect of invention is different because, with regard to horizontal relationships between attributes on a node, formulas that make up a circular reference, are altered/restructured into equivalent expressions and in such a way, that if one of the formulas is viewed as the starting point or the input into the data network (and hence is not a formula), this then breaks the circular reference. The vertical relationships are treated differently in that they relate to specific additive functions and not (in general) to general formulas.

The formula as described herein may be an output.

Advantages provided by the present invention comprise the following:
Users can resize a window diagonally with one gesture and adjoining windows will adjust accordingly without any overlap.
A tiling system that maintains vertical as well as horizontal alignment across all windows is more intuitive for users because relocating windows is easier i.e. it was in the second or third row.
It gives you complete flexibility in how an individual or an organization constructs the information in the hierarchy
A user/organization can work on the hierarchy either top down or bottom up or a mixture of both.
The input at a node level can be assigned to any one of the Objective attributes and can be based on either what you currently know e.g. this is my budget, or what the desired outcome is e.g. this is the number of Sales required, and
A multi-user environment allows at least two users to independently up date different nodes at any level of an integrated hierarchy on the server.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIGS. 1 to 11 illustrate examples according to the first aspect disclosed herein;

FIG. 12 shows an example of a state diagram for the parent to child relationship of an Objective attribute; and

FIG. 13 shows examples how the different constraints and capabilities are granted for a sequence of three locks on the same subtree.

### DETAILED DESCRIPTION

### First Aspect

This aspect is directed to the resizing of windows. This aspect addresses the problem by placing all open, dependant windows within a rectangular space, removing the exclusively vertical or exclusively horizontal restriction and controlling the resizing of multiple sliders via an Intersect Button, which may move diagonally.

The window resizing dependencies are controlled by the placement of sliders along all common window boundaries. Where two sliders on different axis meet or cross over each other, an Intersect Button is positioned.

This Intersect Button is useful because it controls the behaviour of the intersecting sliders with just one action.

In addition to the Intersect Button, this aspect of invention also describes a specific behaviour that is assigned to windows when a slider is moved and it comes into contact with another slider on the same axis.

This behaviour can also be applied to the restrictive case where all open windows are configured in either an exclusively vertical or exclusively horizontal arrangement. In such a case, the synchronization of the tiling is achieved solely

### In General

In general, the movement of objects is based on the movement of the sliders.
If a slider is being controlled by a user and crosses another slider then the latter slider is added to the back of the initial slider's queue and moves with the initial slider.
The sliders have a natural vertical or horizontal order i.e. vertical sliders are ordered from the left 1, 2, 3 etc. and horizontal sliders are from the top 1, 2, 3 etc.
If the slider that is being controlled is already in a queue and hence shares the same location with one or more other sliders then:
   1. If a user action moves a vertical slider to the right then any vertical sliders in the queue with a higher order number move to the right with it.
   2. If a user action moves a vertical slider to the left then any vertical sliders in the queue with a lower order number move to the left with it.
   3. If a user action moves a horizontal slider downwards then any horizontal sliders in the queue with a higher order number move downwards with it.
   4. If a user action moves a horizontal slider upwards then any horizontal sliders in the queue with a lower order number move upwards with it.
Unless it is being directly controlled by the user all Intersect Buttons will reposition themselves based on input from their related sliders.

### Associated System Actions

At any time windows can be moved by simply picking up a window and placing it in another space. If that space is already occupied then that window is swapped to the space from where the grabbed window was initially located.

At any time, additional windows can be opened or already opened windows can be resized from a minimized or maximised state—these actions chance the overall number of open windows presented within the tiled interface. Consequently, these actions require the application to provide a different configuration each time and hence retile the interface.

### First Embodiment

The resizing dependencies are based on the valid movements for three user interface components (control items), the Intersect Button, the horizontal slider and the vertical slider.

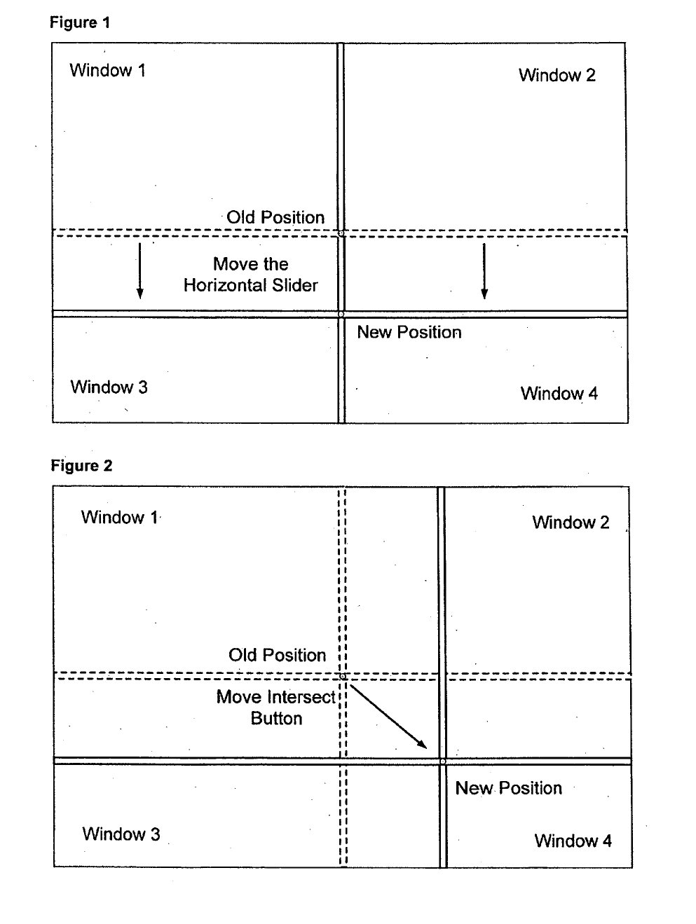

Horizontal sliders separates rows of windows i.e. in FIG. 1 there is one horizontal slider that separates Windows 1 & 2 from 3 & 4. Similarly, vertical sliders separate columns of windows i.e. in FIG. 1 there is one vertical slider that separates Windows 1 & 3 from 2 & 4.

In respect of resizing of windows, for example as shown in FIG. 2:
A horizontal slider changes the y axis values of all of the windows in the row above it by the same amount and the y axis values of all of the windows in the row below it by the additive inverse of that amount.
Similarly, a vertical slider changes the x axis values of all of the windows in the row to its left by the same amount and the x axis values of all of the windows to its right by the additive inverse of that amount.
The Intersect Button is placed at the intersection of all horizontal and vertical sliders and combines the capability of the horizontal and vertical sliders in one action. That is, it will move both the sliders it is placed on, and have the same effect on the adjacent windows as if there were two separate actions (see FIG. 2).
The Intersect Button moves because it is either being directly manipulated by the user and it is controlling the movement of its' related sliders or one of its' related sliders is being directly manipulated and it is responding to a change in the slider's position.

The Intersect Button, as with the sliders, does not have to be an always visible and continuous component, and it may be represented by a multi directional grab icon that sits on the intersection and on ‘mouse over’ becomes visible and active.

### Second Embodiment

### Where Slider Clods not Continue Past Another Slider

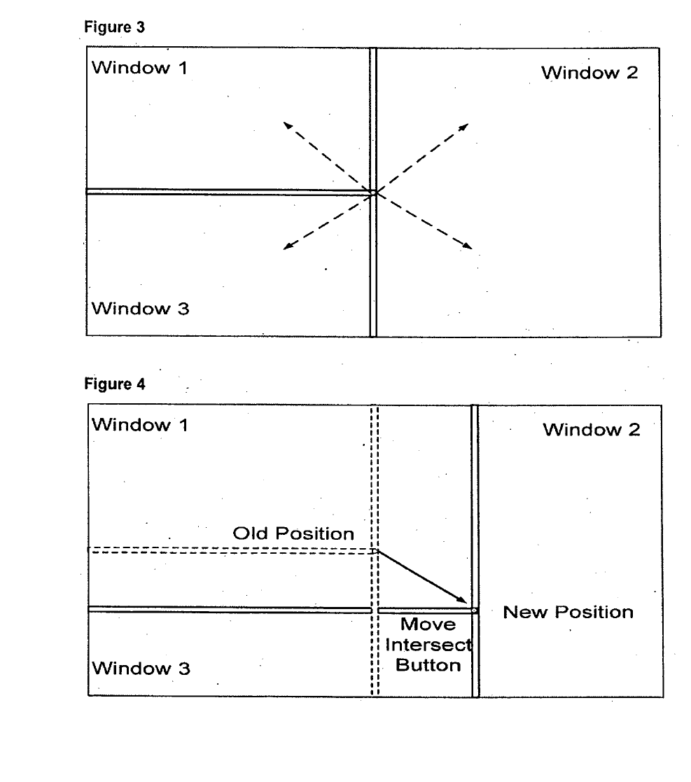

FIG. 3 is an example with only three windows. In this case the horizontal slider intersects the vertical slider but does not continue past it. Because the two sliders are intersecting then an Intersect button can still be used to combine the capability of the horizontal and vertical sliders in one action (see FIG. 4).

### Third Embodiment

### The Interaction of Multiple Sliders that Share the Same Axis

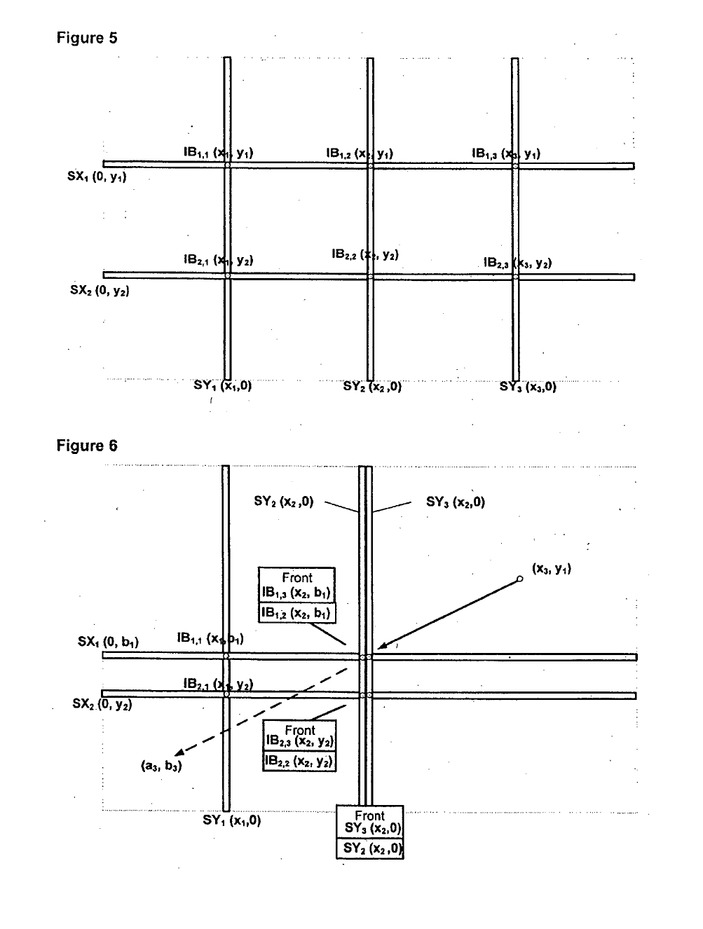

FIG. 5 represents an example with twelve open windows. Controlling the resizing of these windows are two horizontal sliders (SX1, SX2), three vertical sliders (SY1, SY2, SY3)' and six Intersect Buttons (IB1, IB2, IB3, IB4, IB5, IB6).

If a selected slider or one of its' Intersect Buttons is moved directly by the user in either direction and it then encounters another slider that shares the same axis, then it indirectly moves the encountered slider in the same direction.

Regardless of whether the sliders, and their Intersect Buttons, are placed alongside each other or on top of each other, as they cross each other they are grouped via a series of queues (see FIG. 6). At the front of any queue are the slider(s) being controlled by a user action, that is, a slider being directly controlled or the related sliders of an Intersect Button that is being directly controlled.

In a similar way the Intersect Buttons are queued when they cross over each other.

This aspect relates to whether sliders are placed alongside each other and all sliders are visible (as in FIG. 6) or on top of each other and only the slider at the front of the queue are visible. If the sliders are placed alongside each other then the slider being controlled pushes the other slider in front of it. If the controlled slider is placed on top, then the other slider moves in unison but is not visible. FIG. 6 shows that as IB1,3 is moved through (x₂,b₁) on its way to (a₃,b₃) which causes SY3 to cross over SY2 which in turn causes these sliders to be placed in a queue and all buttons based on these vertical sliders to be place in respective queues.

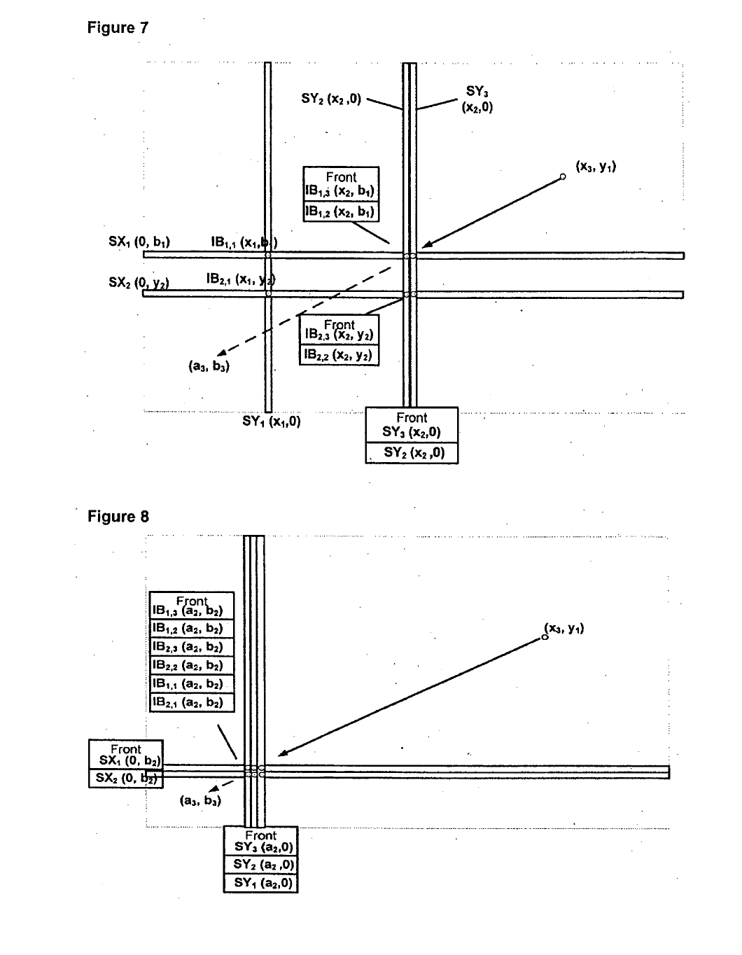

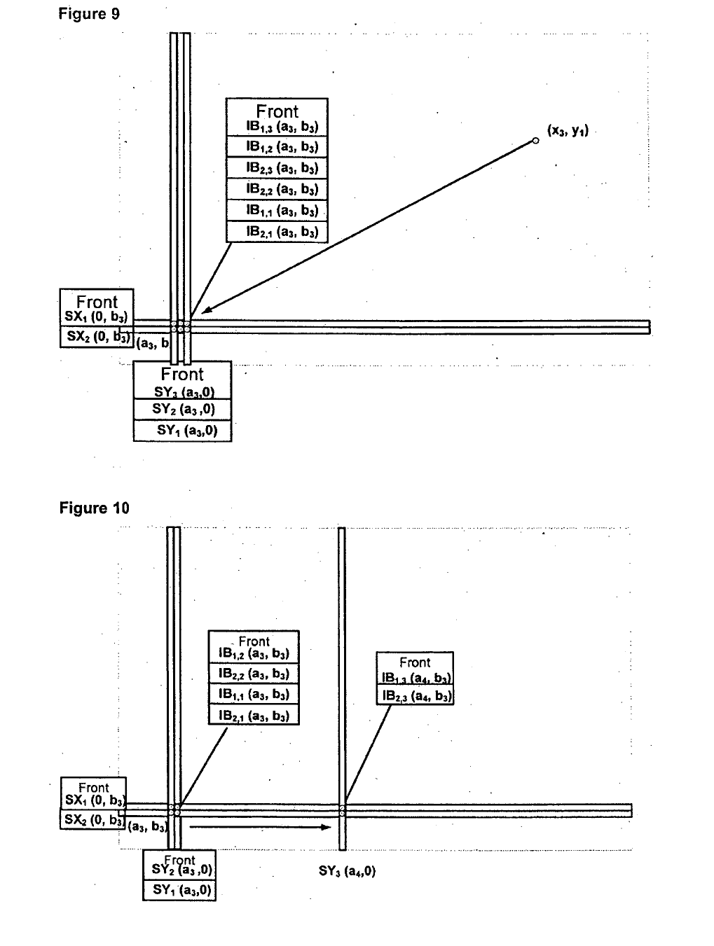

The queues are important because they keep track of all of the control objects that are being moved in unison. As new sliders and Intersect buttons are crossed these objects are added to the bottom of the queue (see FIGS. 7, 8 and which causes SX1 to cross over SX2 which in turn causes these sliders to be placed in a queue and all buttons based on these vertical sliders to be placed in respective queues. At this stage the two Intersect Button queues that were moving with the SY3/SY2 queue have now been merged into one queue with the Intersect button queue attached to SX1 being placed a the front of the merged queue. FIG. 8 shows IB1,3 continuing to move through (a₂,b₂) on its way to (a₃,b₃) which causes the queue SY3/SY2 to cross over SY1 which causes this slider to be added to the back of the queue. At this stage the two Intersect Button queues that were moving with the SX1/SX2 queue have now been merged into one queue with the Intersect button queue attached to the SY3/SY2 queue being place at the front of the merged Intersect Button queue. In FIG. 9, IB1,3 is shown stopping at (a₃,b₃).

In addition to their role of grouping the moving objects, if the control objects are placed on top of each other, rather than alongside, the queues determine the order in which they are stacked i.e. the front of the queue is also the top of the stack and is the control object that is visible.

Similarly, when it comes to unstacking, the queue will unstack in any order as determined by the user.

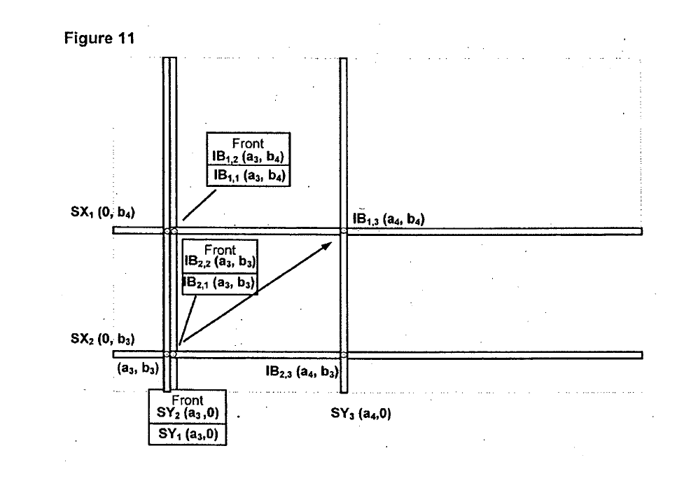

From the example illustrated in FIG. 9, the user may choose to move a slider as in FIG. 10 or an Intersect Button as in FIG. 1. Specifically, FIG. 10 shows the slider SY3 being moved by the user to the right and stopping at (a₄) and the associated Intersect Buttons are moved to a new queue. FIG. 11 shows Intersect Button IB1,3 being moved by the user from (a₃,b₃) and stopping at (a₄,b₄). The associated Sliders are moved and taken out of their queues. This causes the Intersect Buttons related to those sliders to do the same.

### Second Aspect

In this aspect of invention, the description and related embodiments detail a hierarchy of nodes and their attributes which form a matrix of cells linked by multidirectional formulas where each cell can act in both input and output modes. In a further embodiment, this aspect of invention details how this ‘Smart Hierarchy’ operates in a shared, multi user (session) environment where different parts of the hierarchy can be simultaneously viewed and updated by different this aspect of invention is different because, with regard to horizontal relationships between attributes on a node, formulas that make up a circular reference, are altered/restructured into equivalent expressions and in such a way, that if one of the formulas is viewed as the starting point or the input into the data network (and hence is not a formula), this then breaks the circular reference. The vertical relationships are treated differently in that they relate to specific additive functions and not (in general) to general formulas.

In a standard spreadsheet, cells that have formulas must also be output cells. However, in our system, a specific cell can be used in either input or output modes and the formula just defines the relationship the output cell has to other cells. The fact that a cell can be treated as both input and output/formula can probably be viewed has a consequence or benefit, of removing circular references rather than a prerequisite for these approaches.

In accordance with an embodiment of this aspect of invention, there are defined two relationships, namely ‘Additive Hierarchy’ and ‘Objectives’. The ‘Additive Hierarchy’ relates to the vertical relationships in the matrix i.e. the relationships between the same attributes up and down the hierarchy. The ‘Objectives’ relate to the horizontal relationships i.e. the relationships between different attributes on the same node. The ‘type’ of relationship, as it were, may be user defined, and/or may also be dependent upon the application of the matrix; I.e. for what purpose is the matrix used. For example, the relationship may be a mathematical operation and/or formulation of any kind, such as additive or some other operation.

The term ‘matrix’ is being used in a general sense to mean a two dimensional structure of related elements rather than in a specific mathematical meaning. The term ‘matrix’ also captures the two dimensional aspects of a redefinition hierarchy, spreadsheet or other matrix representation. Further detail is given below.

### Additive Hierarchy

The following description discloses a specific embodiment of the present inventive aspect and describes how instances of the same, numerical attribute interact with each other up and down a redefinition hierarchy. The present aspect This may be embodied in a matrix, spreadsheet, or any other form representative of a hierarchy.

A hierarchy can be viewed as a specific type of matrix where the vertical relationships exist, preferably where vertical relationships are relatively consistent for the whole or a substantial portion of a matrix. The vertical relationship should reflect a relationship between a parent node and related children. For example, for numerical attributes, that relationship could theoretically be any mathematical function e.g. additive, averaging, median etc. or any other mathematical operation and/or formulation. In the case where the operation is ‘additive’, there has been found to be a general usefulness in as much as an input into one cell of a matrix can be reflected and/or can influence another cell (because, for example the contents of that one cell are added to the contents or another cell in the additive relationship).

A redefinition hierarchy is where the children of any node may redefine the parent. This is done by the children holding information that is generally consistent with the information held on the parent, but where the children may also be more specific. Vertical consistency between a parent and its child Objective attributes is maintained by defining the parent and child relationship, for example by defining in terms of a mathematical operation, such as an additive type function.

This means that the objects represented in the hierarchy belong to the same class hierarchy. Certain attributes within a class, the Objective attributes (see ‘Objectives’ below), may have numerical properties which are used to maintain consistency up and down the hierarchy.

Introducing Super and Sub Additive relationships into the redefinition hierarchy allows a user to freeze the value of an Objective attribute on one node, while allowing editing to continue on either its parent or its children. When a user freezes a value, the value, for the time being, will not change. If the relationships were solely defined by a straight Additive function rather than Super and Sub. Additive ones, then freezing one node would ‘lock’ the whole hierarchy.

Additive type functions are defined as those that sum (depends on the type of matrix or mathematical operation) numerical type attributes up a hierarchy and A Super Additive function is where the parent can have a value that is greater but not less than the sum of its children. A Sub Additive function is where the parent can have a value that is less but not greater than the sum of its children.

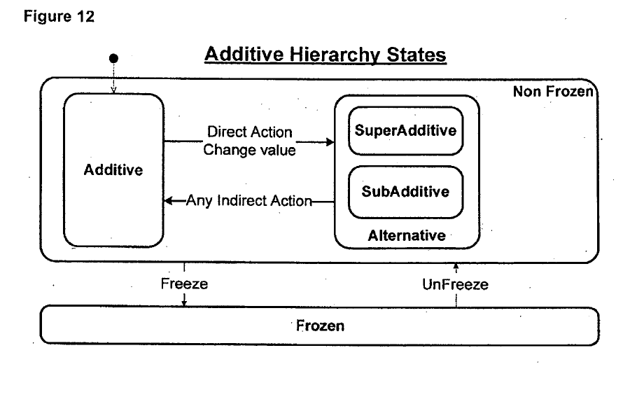

Additive attributes have a distinctive state diagram that specifies the relationships that can exist between a parent node and its children. It is preferable that these relationships are maintained across a multi user (session), client server environment. FIG. 12 shows an example of a state diagram for the parent to child relationship of an Additive attribute. The predefined starting state for these attributes, in this example, may be set so that a parent attribute is Additive in relation to its children, which means that it is equal to the sum of its children. The predefined state may however be set according to any other particular requirements. In another example, it is possible to set the relationship to any of the base states, such as those shown in FIG. 12 i.e. Frozen, SuperAdditive or SubAdditive, or in fact to reflect any other desired relationship.

In addition to its ‘natural’ state, any instance (node or relationship) of an Additive attribute in the Hierarchy can be assigned an Alternative state which defines an alternative response. For example, in the instance where there is a direct edit from the User i.e. the User is specifically setting a value and does not want the system to respond in a purely additive way.

If the Alternative state is set to SuperAdditive', then in this instance, the parent can reflect a result with in a value higher than the sum of its children.

If the Alternative state is set to SubAdditive', then in this instance, the parent can reflect a result with a value lower than the sum of its children.

Any instance of an Additive attribute can also be affected from indirect actions, e.g. updates higher or lower in the hierarchy etc. The instance returns to an Additive state if an indirect action results in the sum of the children equaling the value of the parent or the sum invalidates the Alternative state.

When an instance is ‘Frozen’, the value of the instance cannot be changed until it is ‘unfrozen’, and its relationship to its children is preserved. This means that the sum of the children will continue to be either, Additive, SuperAdditive or SubAdditive but any indirect action cannot alter the value of a Frozen instance.

### Objectives

This section discloses horizontal relationships in the matrix, i.e. the relationships within a set of attributes on the same node and are called Objective attributes. The Objectives functionality is a technique (for example the development of a Tait sequence) that could be applied to any set of related cells (for example with the same node/parent) in a matrix. Again, for example, the relationship between members of the objective relationship may be a mathematical operation and/or formulation of any kind, such as additive or some other operation.

In application to models/spreadsheet calculations, this provides a specific solution for making more dynamic relationships in response to input/output designations.

These Objective attributes can be set by direct data entry or indirectly via a formula containing preferably one, and for example only one, other Objective attribute (defined as its Antecedent) plus a number of other variables that are called Base variables.

The Objective attributes constitute a set of attributes which form a linked, sequential circuit where each Objective attribute is also an Antecedent to one, and only one, other Objective attribute (see Tait sequence below).

Because of this linking, a user can chose to update any Objective attribute and all the other Objective attributes will automatically update. This is achieved by the system assuming that the values of all the Base variables have remained static for a specific update instance.

Obviously, Base variables can change their value over time, i.e. they are by definition, slow changing variables. When these values are changed, then they can cause a recalculation of the Objective attributes and one of the Objective attributes is chosen as the starting point for the round of recalculations i.e. one of the Objective attributes is assumed to be static and the calculation ‘circuit’ is started from the next one in the circuit.

By way of example, only, Table 1 contains a set of simple business formulas that describe the relationships that might exist between Objective Attributes for a basic Sales model.

TABLE 1

| Objective Attribute | Calculation |
|---|---|
| Market Size | Sales/Expected Market Share |
| Investment | (Market Size * Contact Cost) + SetUp Cost |
| Sales | Market Size * Expected Market Share |
| Return | (Sales * Gross Margin) − Investment |

In Table 1 the formulas are presented in a format that is easily understood. These formulas can now be transposed to form a Tait circuit i.e. a sequential circuit of formulas where, for each formula, the single variable on the LHS is defined on the RHS by an expression that contains the previous LHS variable in the circuit (the Antecedent), no other LHS variable of the circuit, and where all the other variables in the expression (the Base variables) are static.

Given the set of Base variables:

Expected Market Share

Contact Cost

SetUp Cost

Gross Margin

And that from the second row:

Market Size=(Investment−SetUp Cost)/Contact Cost

We can substitute Market Size in the third row to rearrange the previous table into an intermediate table as in Table 2.

TABLE 2

| Objective Attribute | Calculation |
|---|---|
| Market Size | Sales/Expected Market Share |
| Investment | (Market Size * Contact Cost) + Setup Cost |
| Sales | ((Investment − SetUp Cost)/Contact Cost) * |
| | Expected Market Share |
| Return | (Sales * Gross Margin) − Investment |

And from the third row of Table 2:

Investment=(Sales*Contact Cost/Expected Market Share)+Set Up Cost

We can now substitute Investment in the fourth row to rearrange Table 2 into a Tait circuit as in Table 3 (Note that the RHS expression of the fourth row has been simplified).

TABLE 3

| Objective Attribute | Calculation |
|---|---|
| Market Size | Sales/Expected Market Share |
| Investment | (Market Size * Contact Cost) + SetUp Cost |
| Sales | ((Investment − SetUp Cost)/Contact Cost) * |
| | Expected Market Share |
| Return | Gross Margin − (Contact Cost/Expected Market |
| | Share) − |
| | (Set Up Cost/Sales) |

Usually a number of constraints need to be applied to a Tait circuit to handle exceptions like divide by zero and enforce common definitions e.g. you cannot have negative sales etc.

In the above example, it can be demonstrated that the cells which comprise the same node or parent, can form members of an ‘objective relationship’. The relationship can be formed, as described, by a mathematical or some other relationship.

### Client & Server Responsibilities on a Client Request for an Edit Space—Objective Attributes

This embodiment comes about in an environment where a number of users have access to the same application. A multi-session environment needs rules to enable particular edits, and not allow certain other edits, as may be defined by the various relationship between members of a matrix. Rules are also needed in the situation where more than one user is seeking to amend (for example) the same cell in a matrix. Of course, such a situation should be avoided, and thus some sense of priority is important. Thus the provision of exclusive or priority editing is provided.

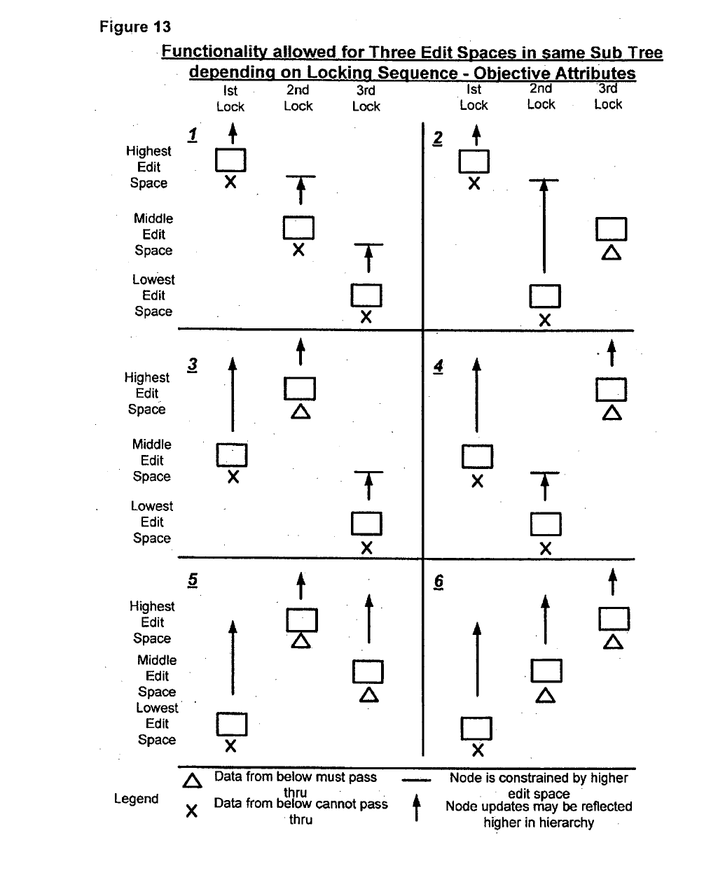

FIG. 13 illustrates a number of ‘rules’ applicable in this embodiment of invention. Six rules are described. FIG. 13 shows examples how the different constraints and capabilities are granted for a sequence of three locks on the same sub-tree. The ‘edit space’ reflects the node or parent in the matrix, with the ‘highest’ being a higher node than ‘lowest’, and ‘lock’ indicates a locking sequence.

Rule 1: where a first user working in a high node locks before other users, blocked from a higher node by the first user, and the third user is blocked from the middle and higher nodes by the second and first users;

Rule 2: where a second user working on a low node locks before a third user working on a middle node, the data from the second user has precedence over data from the third user, even though the third user is working on a higher node than the second user;

Rule 3: where a first user working on a middle node locks before a second user working on a high node, the first user has precedence over the second user; a third user working on a low node is blocked from a middle or high node by the first user;

Rule 4: where a first user working on a middle node locks before a third user working on a high node, the first user working on the middle node has precedence over the third user; a second user working on a low node is blocked by the first user,

Rule 5: where a first user working on a low node locks before a second and third user working on higher and middle nodes, respectively, the first user has precedence over the second and third users;

Rule 6: where a first user working on a low node locks before a second and third user working on higher and middle nodes, respectively, the first user has precedence over the second and third users; the second user who locked before the third user also has precedence over the third user.

In applying the rules, to allow simultaneous, multi user access to a Hierarchy, then a User (on the client) needs to ask that an exclusive edit (lock) serves to be applied to a subsection of nodes that the user may specifically want to enter input data into, or otherwise edit.

The subsection of nodes that have been locked by an edit session is called the Edit Space.

When a client requests an Edit Space to be locked, the server performs a number of checks that can result in both server and client actions. The server checks for any existing edit locks below the requested space and in the same subtree. If there is no lower Edit Space at the time of request then the lower boundary of the requesting Edit Space is effectively frozen i.e. if a lower Edit Space is subsequently defined then that lower space cannot update beyond the boundary of the higher space.

Note that:
The boundary of the higher Edit Space includes any remainder between its value and the sum of its children.
The temporary freeze is actually applied to the immediate children outside the Edit Space
The temporary freeze does not effect the underlying Additive state of the Objective attributes on the children
There may be more than one node at the same, lowest, level

If the requesting Edit Space has its lower boundary frozen then it also has the capability to apply an Additive freeze to any instance of an Objective attribute in its Edit Space.

The server may also check for any constraints that exist in the Hierarchy above the requesting Edit Space and in the same subtree. Constraints could exist because of Additive freezes on higher instances or because a higher Edit Space has applied a temporary freeze.

In a specific embodiment of the present inventive aspect, the Additive Hierarchy and Objectives work together to achieve an edit, in effect, anywhere in a matrix i.e. the fact that the horizontal formulas only execute on the leaf nodes is a critical piece of an embodiment referred to as a Redefinition Hierarchy.

Furthermore, by restricting the horizontal relationships that exist between the Objective attributes to the leaf nodes of the Redefinition Hierarchy, then in combination with the Additive properties of the Hierarchy, a user can update the Redefinition Hierarchy from any node in the hierarchy and from any Objective attribute.

Editing a leaf node can result in the values changing horizontally on that leaf node before rising vertically up the hierarchy for each attribute.

If the user edits a non leaf node then this can cause the change to ripple down the hierarchy via one attribute, it will then alter one or more leaf nodes, ripple across those leaf nodes and then up the hierarchy for the other attributes.

Provided the user has exclusive edit control over all the Objective attributes on a node, then it can be seen how this embodiment operates in a shared, multi user (session) environment where different parts of the hierarchy can be simultaneously viewed and updated by different users and yet still remain consistent with the specified formulas of the Objective attributes.

Server Responsibilities when a Client Edit Space is Saved

When an Edit Space is saved, then the Server must validate any updates against it's session neutral version of the data and, if valid, then those updates and any reflective consequences up the hierarchy are applied against it's version of the data.

This may involve the updating of both Objective attribute values and also their Additive states. Note that the server does not validate or change the values of attributes below the Edit Space and down the hierarchy because an Edit Space cannot change lower instances of these attributes.

These states may need to be preserved across a multi user environment and, if so, the value of a child cannot be altered if the user does not have edit access rights to the children nodes.

These states and transitions are supported by edit functions on the client and also by both the client and the server in response to a multi session environment. The description discusses specific responsibilities for the client and the server that arise out of the provision of multi session capability.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without) departing from the spirit of the essential characteristics of the invention, it should be understood that the above described embodiments are not to limit the present invention unless otherwise specified, but rather should be construed broadly The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents; but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including; but in no way limited to, analog technologies, digital technologies, optical technologies, wireless technologies (e.g., Bluetooth), networking technologies, and inter-networking technologies. The computer program may be printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1-34. (canceled)

35. A method of resizing a plurality of windows adapted to be displayed in a tiled format on a screen, the method comprising the steps of:
providing a first slider in a first axis to delineate the boundary of at least two windows along the first axis providing a second slider in a second axis to delineate the boundary of at least two windows along the second axis providing at the intersect of the first and second sliders, an intersect button adapted to enable resizing of the windows.

36. A method as claimed in claim 35, wherein sliders are placed at common boundaries of windows.

37. A method as claimed in claim 35, wherein the intersect button enables control of intersecting sliders.

38. A method as claimed in claim 35, where a plurality of first sliders is provided.

39. A method as claimed in claim 38, wherein the first sliders delineate vertical window boundaries.

40. A method as claimed in claim 39, wherein a vertical slider changes the x axis values of all of the windows in the row to it's left by the same amount and the x axis values of all of the windows to it's right by the additive inverse of that amount.

41. A method as claimed in claim 35, wherein a plurality of second sliders is provided.

42. A method as claimed in claim 41, wherein the second sliders delineate horizontal window boundaries.

43. A method as claimed in claim 42, wherein a horizontal slider changes the y axis values of all of the windows in the row above it by the same amount and the y axis values of all of the windows in the row below it by the additive inverse of that amount.

44. A method as claimed in claim 38, wherein when a third slider is moved crossing another slider in the same axis, the another slider moves with the third slider.

45. A method as claimed in claim 44, wherein sliders which are crossed are queued.

46. A method as claimed in claim 35, wherein when a new window is opened, it is incorporated into the existing tiled format.

47. A method as claimed in claim 35, wherein the location of a first window can be swapped with the location of a second window.

48. An application adapted to resize a plurality of windows displayed in a tiled format on a screen, comprising:
a first slider means in a first axis to delineate the boundary of at least two windows along the first axis
a second slider means in a second axis to delineate the boundary of at least two windows along the second axis
at the intersect of the first and second sliders, an intersect button adapted to enable resizing of the windows.

49. An application adapted to implement the method as claimed in claim 35.

50. A method of coordinating relationships between a number of cells in a matrix, the method comprising the steps of:
providing cells with an additive hierarchy relationship
providing cells with an objectives relationship.

51. A matrix, such as an electronic document, spreadsheet or the like, comprising:
a plurality of first and second cells, the first cells having an additive relationship, the second cells having an objectives relationship.

52. A matrix as claimed in claim 51, where the additive relationship relates to the ‘vertical’ relationships in the matrix i.e. the relationships between the same attributes up and/or down the hierarchy and wherein the objectives relationship is relate to the ‘horizontal’ relationships i.e. the relationships between different attributes on the same node.

53. A matrix as claimed in claim 51, wherein a plurality of cells on the same node are operationally related to each other via a Tait sequence.

54. A method of enabling edit space associated with a matrix, the method comprising any one or any combination of:
Rule 1: where a first user working in a high node locks before other users, the second and third users are constrained by the first user; the second user is blocked from a higher node by the first user, and the third user is blocked from the middle and higher nodes by the second and first users;
Rule 2: where a second user working on a low node locks before a third user working on a middle node, the data from the second user has precedence over data from the third user, even though the third user is working on a higher node than the second user;
Rule 3: where a first user working on a middle node locks before a second user working on a high node, the first user has precedence over the second user; a third user working on a low node is blocked from a middle or high node by the first user;
Rule 4: where a first user working on a middle node locks before a third user working on a high node, the first user working on the middle node has precedence over the third user; a second user working on a low node is blocked by the first user;
Rule 5: where a first user working on a low node locks before a second and third user working on higher and middle nodes, respectively, the first user has precedence over the second and third users;
Rule 6: where a first user working on a low node locks before a second and third user working on higher and middle nodes, respectively, the first user has precedence over the second and third users; the second user who locked before the third user also has precedence over the third user.
Rule 7: to allow simultaneous, multi user access to a Hierarchy, then a User (on the client) needs to ask that an exclusive edit (lock) serves to be applied to a subsection of nodes that the user may specifically want to enter input data into, or otherwise edit.
